(19) United States
(12) Patent Application Publication
(10) Pub. No.: US 2016/0253040 A1
(43) Pub. Date: Sep. 1, 2016

(54) ELECTRONIC DEVICE INCLUDING TOUCH KEY AND TOUCH KEY INPUT PROCESSING METHOD

(71) Applicant: Samsung Electronics Co., Ltd., Gyeonggi-do (KR)

(72) Inventors: Keun Sik LEE, Gyeonggi-do (KR); Hoon Do HEO, Gyeonggi-do (KR)

(21) Appl. No.: 15/054,709

(22) Filed: Feb. 26, 2016

(30) Foreign Application Priority Data
Feb. 27, 2015 (KR) 10-2015-0028652

(51) Int. Cl. G06F 3/041; G06F 3/044

(52) U.S. Cl. CPC G06F 3/0418; G06F 3/044; G06F 2203/04106

(57) ABSTRACT

An electronic device and method may provide accurate touch input recognition in a touch key area with high sensitivity while preventing false inputs from proximate touches. The method may involve recognizing a first signal and a second signal detected by an input on the touch key area; and processing the input on the touch key area based on at least a comparison result of the first signal and the second signal. The first and second signals may be indicative of capacitance changes occurring at different locations within the touch key area.

### CLAIM OF PRIORITY

This application claims the benefit under 35 U.S.C. §119(a) of a Korean patent application filed on Feb. 27, 2015 in the Korean Intellectual Property Office and assigned Serial number 10-2015-0028652, the entire disclosure of which is hereby incorporated by reference.

### TECHNICAL FIELD

The present disclosure relates to an electronic device including a touch key and a touch key input processing method.

### BACKGROUND

A touch recognition function is used in many of today's consumer electronic devices. For example, a touch recognition function as in a touch screen is applied to a mobile terminal (for example, a smartphone, a tablet, and a wearable device), a PC or a large TV.

Some electronic devices with touch screens employ a touch panel for the touch recognition function of the touch screen, and also include a touch key structure adjacent to the touch screen. A predetermined function or menu, which is frequently used in applications or commonly used, may be mapped into a touch key. A user may execute a specified function or call a sub menu by selecting such a touch key.

A technique used for a touch key or touch recognition may be largely divided into a resistive method (or a pressure recognition method) and a capacitive method (or an electrostatic method). Besides these, various alternative technologies may be used; but recently, due to manufacturing processes, costs, user experiences, and recognition sensitivities, the capacitive method is typically preferred.

The capacitive method uses the charging/discharging characteristics of a capacitor, which is employed as a passive device. When an object with capacitance, for example, a user's finger or a specially designed pen (for example, a stylus), contacts a sensor, a change in electrical field between two electrodes occurs, and the electronic device may determine whether and where a touch input occurs based on this change. Unlike a resistive method that requires physical contact with a touch sensor/panel surface, a change in capacitance is detectable when a touch input means (e.g., finger, stylus, touch pen) is proximate but not in direct contact with the surface. This enables a touch sensor or a touch screen panel to be protected with glass (e.g., enhanced glass) or a designed cover.

Recently, portable electronic devices which allow touch input function through an electronic pen have become popular. Examples include smartphones, phablets, and tablets with a display size of about 5.3-6.9″. Some of these products have more recognition sensitivity than those designed for an early stage electronic pen. While the electronic pen is actively used on the touchscreen, the user may also use either the electronic pen or his/her finger for inputs to the touch key. It is noted here that an “electronic pen” is an example of a touch input tool, and the term may be used herein interchangeably with terms such as stylus, touch pen, digitizer, etc. The term “touch input tool” as used herein generally refers any capacitive touch input device other than a user's finger. “Electronic pen” often connotes a touch pen with active wireless communication, but such wireless communication may not be relevant to the touch input mechanisms described herein.

When a touch key is designed to sufficiently recognize a touch input through a user's finger, an input using a stylus or digitizer (for example, a pen tip for a touch pen is 1 mm to 2 mm across), which has a relatively small touch area, may not be recognized. Some devices have been designed to resolve this problem via the use of a highly sensitive touch key.

However, while increasing the sensing sensitivity of the touch key may resolve the issue of detecting an electronic pen's input, due to a high sensitivity of the touch key, the touch input of an input means with a wide touch input (for example, a finger) may be recognized even in a proximate-contact state, i.e., a hovering state. This results in a higher occurrence of erroneous inputs.

### SUMMARY

Accordingly, an aspect of the present disclosure is to provide a touch key input processing method for distinguishing a touch input when an input means contacts a touch key physically from a touch input when the input means is close to the touch key and rejecting the touch input when the touch input occurs by the proximity, and an electronic device for supporting the same.

In accordance with an aspect of the present disclosure, an electronic device includes: a housing including a first surface; a touch key area disposed at a portion of the first surface; an integrated circuit configured to detect an input through the touch key area; and a processor electrically connected to the integrated circuit. First, second and third conductive lines may be separated from one another and may each connected between the touch key area and the integrated circuit. The first conductive line may be a transmit channel line connected at a first point on the touch area. The second conductive line may be a first reception channel line providing a first signal indicative of a first change in capacitance, due to at least one external object, between conductive elements at a first location within the touch key area. The third conductive line may be a second reception channel line providing a second signal indicative of a second change in capacitance, due to the at least one external object, between conductive elements at a second location within the touch key area.

In another aspect, a method may involve recognizing a first signal and a second signal detected by an input on the touch key area; and processing the input on the touch key area based on at least a comparison result of the first signal and the second signal. The first and second signals may be indicative of capacitance changes occurring at different locations within the touch key area.

### BRIEF DESCRIPTION OF THE DRAWINGS

FIG. 1 is a view illustrating a configuration of an electronic device (for example, a user terminal) according to an embodiment of the present disclosure.

FIG. 2 is a view illustrating an entire circuit for driving a touch key of an electronic device according to an embodiment of the present disclosure.

FIG. 3 is a view illustrating a touch detection circuit configuration of a touch key according to an embodiment of the present disclosure.

FIG. 4 is a view illustrating a recognition range of a touch detection circuit according to an embodiment of the present disclosure.

FIG. 5 is a view illustrating a recognition range of a touch detection circuit according to another embodiment of the present disclosure.

FIG. 6 is a flowchart illustrating a touch input recognition process of a touch key according to an embodiment of the present disclosure.

FIG. 7 is a block diagram of an electronic device according to an embodiment of the present disclosure.

### DETAILED DESCRIPTION

Hereinafter, various embodiments of the present disclosure are disclosed with reference to the accompanying drawings. However, this does not limit various embodiments of the present disclosure to a specific embodiment and it should be understood that the present disclosure covers all the modifications, equivalents, and/or alternatives of this disclosure provided they come within the scope of the appended claims and their equivalents. With respect to the descriptions of the drawings, like reference numerals refer to like elements.

The term “include,” “comprise,” and “have”, or “may include,” or “may comprise” and “may have” used herein indicates disclosed functions, operations, or existence of elements but does not exclude other functions, operations or elements. For instance, the expression “A or B”, or “at least one of A or/and B” may indicate include A, B, or both A and B. For instance, the expression “A or B”, or “at least one of A or/and B” may indicate (1) at least one A, (2) at least one B, or (3) both at least one A and at least one B.

The terms such as “first”, “second”, and the like used herein may refer to modifying various different elements of various embodiments of the present disclosure, but do not limit the elements. For instance, “a first user device” and “a second user device” may indicate different users regardless of the order or the importance. For example, a first component may be referred to as a second component and vice versa without departing from the scope of the present disclosure. In various embodiments of the present disclosure, it will be understood that when a component (for example, a first component) is referred to as being “(operatively or communicatively) coupled with/to” or “connected to” another component (for example, a second component), the component may be directly connected to the other component or connected through another component (for example, a third component). In various embodiments of the present disclosure, it will be understood that when a component (for example, a first component) is referred to as being “directly connected to” or “directly access” another component (for example, a second component), another component (for example, a third component) does not exist between the component (for example, the first component) and the other component (for example, the second component).

The expression “configured to” used in various embodiments of the present disclosure may be interchangeably used with “suitable for”, “having the capacity to”, “designed to”, “adapted to”, “made to”, or “capable of according to a situation, for example. The term “configured to” may not necessarily mean “specifically designed to” in terms of hardware. Instead, the expression “a device configured to” in some situations may mean that the device and another device or part are “capable of”. For example, “a processor configured to perform A, B, and C” in a phrase may mean a dedicated processor (for example, an embedded processor) for performing a corresponding operation or a generic-purpose processor (for example, a CPU or application processor) for performing corresponding operations by executing at least one software program stored in a memory device.

Terms used to describe various embodiments of the present disclosure are used to describe specific embodiments of the present disclosure, and are not intended to limit the scope of other embodiments. The terms of a singular form may include plural forms unless they have a clearly different meaning in the context. Otherwise indicated herein, all the terms used herein, which include technical or scientific terms, may have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning. In any cases, even the terms defined in this specification cannot be interpreted as excluding embodiments of the present disclosure.

According to various embodiments of the present disclosure, electronic devices may include at least one of smartphones, tablet personal computers (PCs), mobile phones, video phones, electronic book (e-book) readers, desktop personal computers (PCs), laptop personal computers (PCs), netbook computers, workstation server, personal digital assistants (PDAs), portable multimedia player (PMPs), MP3 players, mobile medical devices, cameras, and wearable devices (for example, smart glasses, head-mounted-devices (HMDs), electronic apparel, electronic bracelets, electronic necklaces, electronic appcessories, electronic tattoos, smart mirrors, and smart watches). Hereinafter, an electronic device according to various embodiments of the present disclosure will be described in more detail with reference to the accompanying drawings. The term “user” in this disclosure may refer to a person using an electronic device or a device using an electronic device (for example, an artificial intelligent electronic device).

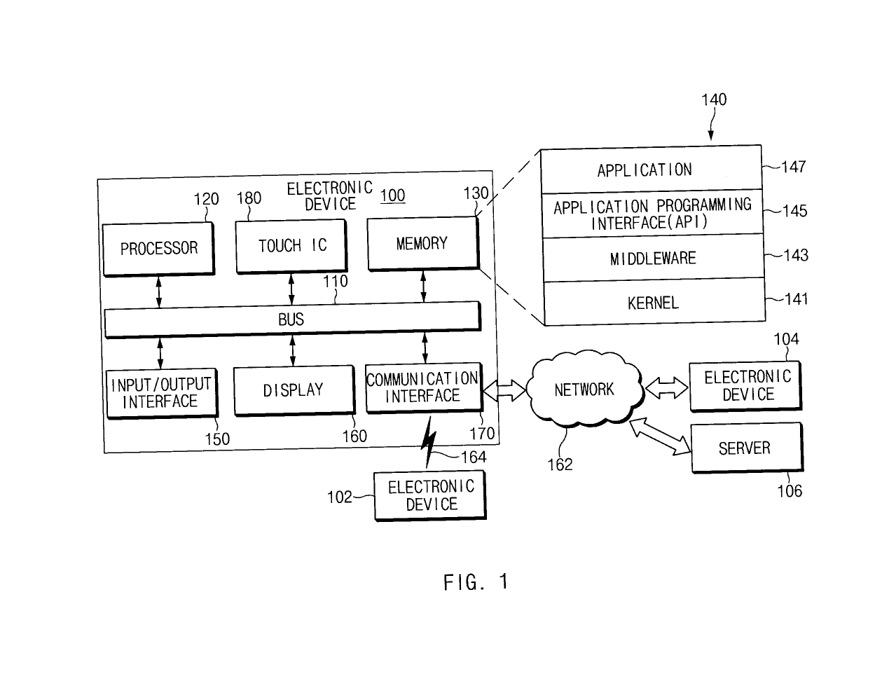

FIG. 1 is a view illustrating an exemplary configuration of an electronic device, 100 (for example, a user terminal), according to various embodiments of the present disclosure. Electronic device 100 may include a bus 110, a processor 120, a memory 130, an input/output interface 150, a display 160, a communication interface 170, and a touch integrated circuit (IC) 180. In other designs, electronic device 100 may omit at least one of the components or may additionally include a different component(s) to those described below.

The bus 110, for example, may include a circuit for connecting the components 120 to 180 to each other and delivering a communication (for example, control message and/or data) between the components 110 to 180.

The processor 120 may include at least one of a central processing unit (CPU), an Application Processor (AP), and a communication processor (CP). The processor 120, for example, may execute calculation or data processing for control and/or communication of at least one another component of the electronic device 100.

The memory 130 may include volatile and/or nonvolatile memory. The memory 130, for example, may store instructions or data relating to at least one another component of the electronic device 100. According to an embodiment of the present disclosure, the memory 130 may store software and/or program 140. The program 140 may include a kernel 141, a middleware 143, an application programming interface (API) 145, and/or an application program (or an application) 147. At least part of the kernel 141, the middleware 143, and the API 145 may be called an operating system (OS).

The kernel 141, for example, may control or manage system resources (for example, the bus 110, the processor 120, the memory 130, and so on) used for performing operations or functions implemented in other programs (for example, the middleware 143, the API 145, or the application program 147). Additionally, the kernel 141 may provide an interface for controlling or managing system resources by accessing an individual component of the electronic device 101 from the middleware 143, the API 145, or the application program 147.

The middleware 143, for example, may serve as an intermediary role for exchanging data as the API 145 or the application program 147 communicates with the kernel 141.

Additionally, the middleware 143 may process at least one job request received from the application program 147 according to a priority. For example, the middleware 143 may assign to at least one application program 147 a priority for using a system resource (for example, the bus 110, the processor 120, or the memory 130) of the electronic device 101. For example, the middleware 143 may perform scheduling or load balancing on the at least one job request by processing the at least one job request according to the priority assigned to the at least one job request.

The API 145, as an interface for allowing the application 147 to control a function provided from the kernel 141 or the middleware 143, may include at least one interface or function (for example, an instruction) for file control, window control, image processing, or character control.

The input/output interface 150, for example, may serve as an interface for delivering instructions or data inputted from a user or another external device to another component(s) of the electronic device 100. Additionally, the input/output interface 150 may output instructions or data received from another component(s) of the electronic device 100 to a user or another external device.

The display 160, for example, may include a liquid crystal display (LCD), a light emitting diode (LED) display, an organic light emitting diode (OLED) display, a microelectromechanical systems (MEMS) display, or an electronic paper display. The display 160 may display various contents (for example, text, image, video, icon, symbol, and so on) to a user. The display 160 may include a touch screen, and for example, may receive a touch, gesture, proximity, or hovering input by using an electronic pen or a user's body part.

The communication interface 170, for example, may set a communication between the electronic device 100 and an external device (for example, the first external electronic device 102, the second external electronic device 104, or the server 106). For example, the communication interface 170 may communicate with an external device (for example, the second external electronic device 104 or the server 106) in connection to the network 162 through wireless communication or wired communication.

The wireless communication, as a cellular communication protocol, may use at least one of long-term evolution (LTE), LTE Advance (LTE-A), code division multiple access (CDMA), wideband CDMA (WCDMA), universal mobile telecommunications system (UMTS), Wireless Broadband (WiBro), Global System for Mobile Communications (GSM), and so on.

Each of the first and second external electronic devices 102 and 104 may be the same type or a different type than electronic device 101. Server 106 may be a singular device or may be a group of servers. All or part of operations executed on the electronic device 101 may be executed on another one or more electronic devices (for example, the electronic device 102 or 104 or the server 106). When the electronic device 101 performs a certain function or service automatically or by a request, it may request at least part of a function relating thereto from another device (for example, the electronic device 102 or 104 or the server 106) instead of or in addition to executing the function or service by itself The other electronic device (for example, the external electronic device 102 or 104 or the server 106) may execute a requested function or an additional function and may deliver an execution result to the electronic device 101. The electronic device 101 may provide the requested function or service as it is or by processing the received result additionally. For this, for example, cloud computing, distributed computing, or client-server computing technology may be used.

The touch IC 180 may process an input on at least one touch key provided at the electronic device 100. Touch IC 180 may process a touch input occurring from a touch key as each touch key is connected to one transmission channel and two or more reception channels. Herein, a transmission channel Tx and a reception channel Rx may be understood as a driving line and a sensing line, respectively.

The touch IC 180 may be connected to the processor 120 through the bus 110. Touch IC 180 may deliver the sensitivity (for example, signal intensity) of a touch input detected through a plurality of reception channels to the processor 120, and the processor 120 may execute a function corresponding to the touch input or reject the touch input based on a touch input sensitivity difference as will be described below. Alternatively, touch IC 180 may perform processing of the touch input. It is noted that touch IC 180 may be understood as a touch driving circuit, a touch module, or a touch control circuit.

Electronic device 100 may additionally include a touch module for driving a touch screen panel (TSP) of the display 160. In another embodiment, the touch IC 180 may drive both a touch key and a touch screen. That is, the touch IC 180 may process a touch input for a TSP.

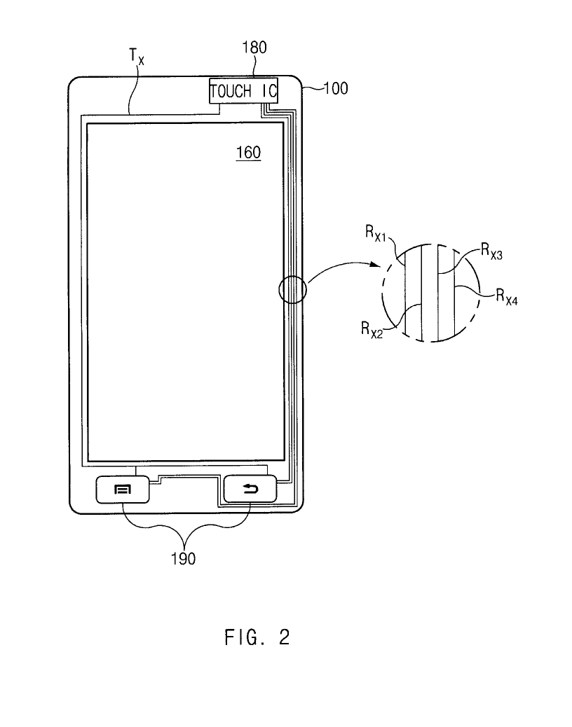

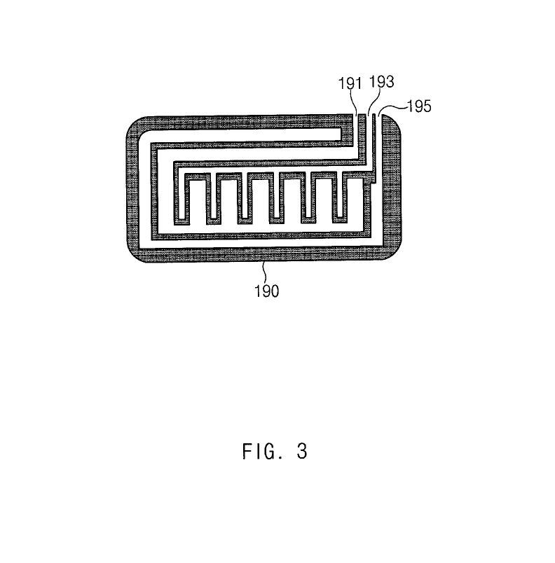

In relation to an example structure of the touch IC 180 and at least one touch key, description is made with reference to FIGS. 2 and 3.

FIG. 2 is a view illustrating an entire circuit for driving a touch key of an electronic device according to an embodiment of the present disclosure. Electronic device 100 may include at least one touch key 190. An example of two touch keys 190 is used in the illustrated embodiment. Further, in the example depicted, a circuit that connects the touch IC 180 and the touch key 190 using conductive lines around the display 160 is shown; however, other arrangements are available. Although not shown in the drawing, a physical button such as a “home” button may be disposed between the two touch keys 190, and other components like a front camera and a receiver may be disposed at the upper end of the display 160.

The touch IC 180 may be connected to each touch key 190 through one transmission channel Tx and two reception channels (Rx1, Rx2 for the right side touch key 190, or Rx3, Rx4 for the left side touch key). As shown in FIG. 2, when two touch keys 190 are disposed at a user terminal, the touch IC 180 may be connected to four receptions channels Rx1, Rx2 (for the right side touch key 190), and Rx3 and Rx4 (for the left side touch key 190). One transmission channel and two reception channels may form a circuit structure for detecting a touch input within the touch key 190 area. In relation to an example internal structure of the touch key 190, description is made with reference to FIG. 3.

In relation to the touch key 190, a transmission channel and at least one of the reception channels may have a pattern structure for forming mutual capacitance. For example, the transmission channel and the one reception channel may be formed to intersect each other in different layers. In this case, a circuit corresponding to another reception channel may be additionally disposed outside the pattern structure.

According to another embodiment, the touch key 190 may include a pattern structure for forming self-capacitance. In this case, one reception channel may be additionally disposed outside the pattern structure. When the touch key 190 is selected by an input means, a specified menu may be outputted to the display 160 or a specified function may be executed. For example, when a touch key (for example, a left touch key) corresponding to a menu button is selected, a menu specified for an application that a user uses frequently or in execution, for example, app and widget addition, folder addition, wallpaper setting, page editing, search, environment setting, and help, may be outputted to the display 160. Additionally, for example, when a touch key (for example, a right touch key) corresponding to a recent button is selected by an input means, a recent task screen (for example, a previous page or a screen outputted immediately before a task) is outputted or an application in execution may be terminated.

The input means may correspond to an object that induces a change in capacitance such as a user's finger or a touch input tool. As noted earlier, a touch input tool may be a touch dedicated electronic pen or a stylus. The electronic pen may be driven through one of a passive method, an active method, or an electromagnetic resonance (EMR) method. If the electronic pen is driven through the EMR method, an additional digitizer may be included.

The touch input tool may be retained within a mounting space inside the electronic device 100 when not being used. For example, while being mounted within the mounting space, an electronic pen may be manually withdrawn by a user through a hole in the housing. In this case, the electronic device 100 may recognize that the input tool is withdrawn and perform an operation for processing “mutual hover” with a user's finger according to an embodiment of the present disclosure. When the input tool remains mounted inside the electronic device 100, it may not initiate mutual hover processing in connection with another input tool.

Hereinafter, a detailed structure of a touch key for processing mutual hover (that is, unintended non-contact touch recognition) occurring from the touch key while performing a highly sensitive touch recognition for input through a touch input tool is described with reference to FIG. 3.

FIG. 3 is a plan view illustrating an exemplary touch detection circuit configuration of a touch key according to an embodiment of the present disclosure. A touch key 190 may include a transmission channel 191 and two reception channels, that is, a first reception channel 193 and a second reception channel 195. The transmission channel 191 and the first and second reception channels 193 and 195 extend from one point in the boundary of the touch key 190 to be electrically connected to the touch IC 180.

A basic circuit configuration for high-sensitive touch recognition may be implemented using the transmission channel 191 and the first reception channel 193.

For example, the transmission channel 191 and the first reception channel 193 may be designed in a mutually intersecting form, such as a form resembling branches, in order to achieve high-sensitive touch recognition performance. Through such a pattern structure, the transmission channel 191 and the first reception channel 193 may form a mutual capacitance. When a touch input tool like an electronic pen having a thin pen tip, for example, an electronic pen having a pen tip of a 1 mm to 2 mm diameter, touches the touch key 190 through such a pattern structure, the electronic device 100 may recognize a touch input by the electronic pen through the branch structure. In contrast, in a convention design in which a reception channel is simply disposed in a form of winding the inside of the touch key 190 once without using a branch structure or a lattice structure, a touch input by a user's finger may be recognizable but a fine touch input on the center portion of the touch key 190 by an electronic pen may not be recognized. Accordingly, as shown in FIG. 3, a high-sensitive touch recognition circuit may be implemented through the transmission channel 191 and the first reception channel 193. As depicted, this may be achievable by providing a conductive pattern in which a central portion of the pattern includes a comb structure (which can also be referred to as a “meandering path”), and peripheral regions of the pattern surrounding the comb structure may include at least one elongated loop.

Additionally, in the case of capacitive touch recognition, even when an input means is close to a touch circuit in some degree, this may be detected as touch recognition (that is, proximity sensing). In a case that the above-mentioned high-sensitive touch recognition circuit is implemented, when an electronic pen with a thin pen tip substantially contacts the surface of a touch key, this may be recognized as a touch input. However in the case of an input means with a broad contact area (for example, a finger), when the input means is relatively far from a touch key, this may be detected as a “mutual hover” condition which corresponds to a user's unintended input.

According to an embodiment, the second reception channel 195 is disposed in a form of winding the transmission channel 191 and the first reception channel 193, and based on a signal detected through the second reception channel 195, the touch IC 180 may distinguish a touch input by contact from an input by non-contact. For example, when an arbitrary input means touches a predetermined area of the touch key 190, an intensity “S1” of a first signal detected through the first reception channel 193 and the intensity “S2” of a second signal detected through the second reception channel 195 may be detected.

In general, some touch input tools may cause smaller changes in capacitance as compared to that due to a user's finger or to other input tools. For instance, contact on the touch key 190 may occur by a first type input means having a relatively small contact area such as a stylus having a diameter of less than 2 mm. If touch sensor sensitivity is set too low, such a stylus may not generate a sufficient change in capacitance with respect to a touch sensor due to a relatively small contact area. Thus sensitivity of a touch circuit may be set to a high or maximum sensitivity to allow the touch IC 180 to recognize a touch contact with a small diameter stylus. In FIG. 3, touch contact with a stylus may sufficiently change capacitance formed by the transmission channel 191 and the first reception channel 193 or the second reception channel 195 so that the touch is recognized as an intentional input.

However, with the sensitivity of the touch key 190 set high, when a second type touch input means like a user's finger or an electronic pen manufactured with a relatively wide contact area mimicking a user's finger capacitance approaches the touch key 190, even if the second type input means is not sufficiently close to the touch key 190, due to the high sensitivity, the touch IC 190 may recognize a touch input as if the touch input by contact occurs.

In the following discussion, a variable “SD” refers to a difference between, or a ratio of, a first signal intensity and a second signal intensity. Now, in the case that the second type input means just mentioned is spaced more than a predetermined distance from the touch key 190, the strength of a signal detected from the first reception channel 193 due to the second type input means may be measured relatively high through a structure (for example, a structure of a plurality of branches) of the first reception channel 193. However, with the second type input means in the same position, the strength of a signal detected from the second reception channel 195 due to the second type input means may be measured relatively low. During this state, the variable “SD1” is assumed to refer to a ratio of or a difference between the intensities of signals detected through the first reception channel 193 and the second reception channel 195. Hereinafter, for convenience of description, SD, SD1, etc. is described as a signal intensity difference.

If the second type input means contacts the surface of the touch key 190, touch signals may be detected in each of the first and second reception channels 193, 195. During this state, a variable “SD2” denotes a difference between signals detected through the first reception channel 193 and the second reception channel 195. The touch IC 180 may process a touch input recognized by the touch key 190 based on a comparison result of the signals. In general, SD2 may have a smaller value than SD1 and the electronic device 100 may set an arbitrary threshold value and determine whether to process a touch input according to whether a detected signal difference is greater or less than the threshold value. For example, a signal difference SD3, when a finger contacts the touch key 190, may be known through experimentation to have a value of 5 units on average, while a signal difference, when a finger is spaced more than 0.2 cm from the touch key 190, may have a value of 7 on average. In this circumstance, if a value of 7 is set as a threshold value, the touch IC 180 may be use the threshold to reject signals as touch inputs when a measured SD value exceeds 7.

Accordingly, when a difference between the first signal and the second signal is greater than a specified threshold value, the touch IC 180 may determine sensed information as mutual hover occurring by non-contact and reject touch input. If a difference between the first signal and the second signal is less than a threshold value, the touch IC 180 may determine the touch input as a touch input by contact and may perform an operation that is mapped into the touch key 190.

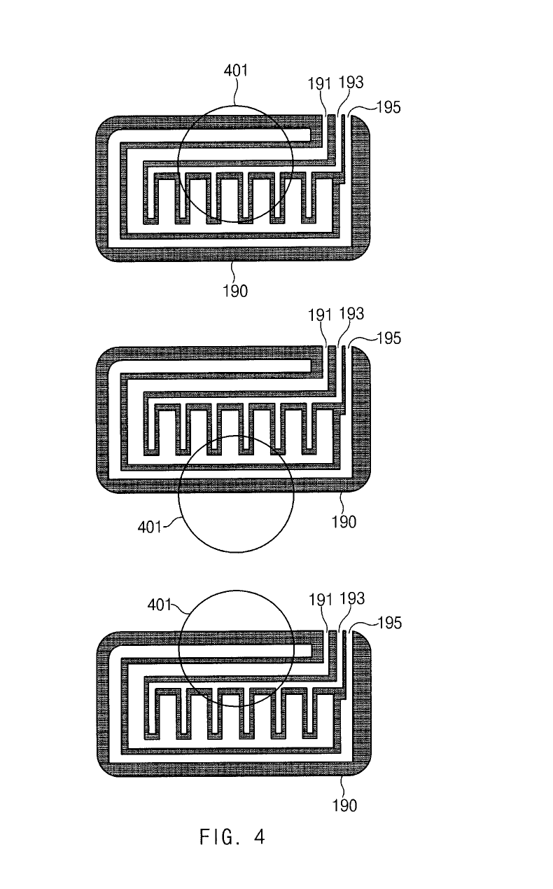

FIG. 4 is a view illustrating a recognition range of a touch detection circuit according to an embodiment of the present disclosure. A touch key 190 shown in FIG. 4 may correspond to the touch key 190 described with reference to FIG. 3. Now, a touch input on the touch key 190 by a user's finger, for example, a second type input means, may occur. For example, under the assumption that an area 401 is an area that is affected from capacitance by a user's finger, when the finger touches around the center of the touch key 190 (central view in FIG. 4); when the finger touches the lower end of the touch key 190 (bottom view); and when the finger touches the upper end of the touch key 190 (upper view), an area corresponding to the first reception channel 193 and the second reception channel 195 may directly contact the finger. (The transmission and reception channels 191, 193, 195 between adjacent conductive traces may be alternatively called “mutual-capacitive channels”, in which the effective capacitance thereof changes due to the contact with touch input means.) In such a case of direct contact of the touch input means concurrently with portions of the first and second reception channels 193 and 195, the intensity of a first signal detected by the first reception channel 193 and the intensity of a second signal detected by the second reception channel 195 may be detected sufficiently strong due to the direct contact state. As a result, a difference between the first signal intensity and the second signal intensity may drop below the threshold value described with reference to FIG. 3. In this case, the electronic device 100 may perform a function corresponding to the touch key 190.

Accordingly, when a user touches the touch key 190 by using a general input means such as a finger, the touch IC 180 may distinguish a touch input (that is, an intentional touch input) by direct contact from a touch input (that is, an unintentional touch input) by mutual hover.

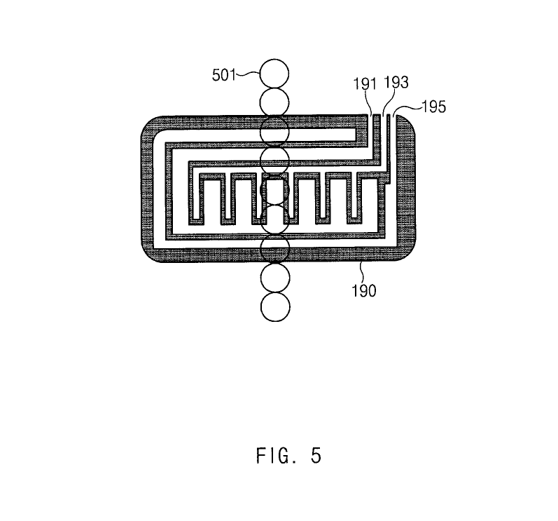

FIG. 5 is a view illustrating a recognition range of a touch detection circuit according to another embodiment of the present disclosure. Similar to FIG. 4, FIG. 5 illustrates a touch input 501 by a first type input means (for example, an electronic pen) having a relatively small diameter. In such a way, when a touch input occurs by an input means having a relatively small touch area compared to the area of the touch key 190, a touch input contacting the surface of the touch key 190 may be recognized from an area inside a pattern formed by at least the transmission channel 191 and the first reception channel 193. However, even when the first type input means contacts the surface of the touch key 190 physically, a sufficient change in capacitance may not be detected from the second reception channel 195. For instance, this may correspond to the case for the centrally located circles illustrated in FIG. 5, each circle depicting a different possible pen tip touch position. That is, when the first type input means directly contacts the touch key 190, a signal difference may be greater than a threshold value. In such a case, when a difference between the first signal (detected in the first reception channel) and the second signal (detected in the second reception channel), or vice versa, is greater than a threshold value and the intensity of the second signal is less than a specified reference (or vice versa), the touch IC 180 may be set to perform a function corresponding to the touch key. However, in the cases by the second type input means and the first type input means, even if a difference between the first signal and the second signal is greater than a threshold value, the intensity of a signal recognized by the second reception channel 195 may be relatively large in the case of the second type input means and based on this, the touch IC 180 may determine an operation of the touch key 190.

In the above-mentioned embodiment, a touch input on the touch key 190 may be processed by the touch IC 180. Alternatively, the touch IC 180 may provide information on the amplitude of a received signal to the processor 120 and the touch input may be processed by the processor 120. Additionally, although a touch key having two reception channels is described in the above-mentioned embodiment, according to other embodiments of the present disclosure, a touch key having three or more reception channels may be provided. In this case, a transmission channel and at least part of a plurality of reception channels may form a pattern structure for touch recognition within a touch key area and at least one reception channel may be disposed in a form of wrapping the remaining reception channels and the transmission channel from a surrounding area.

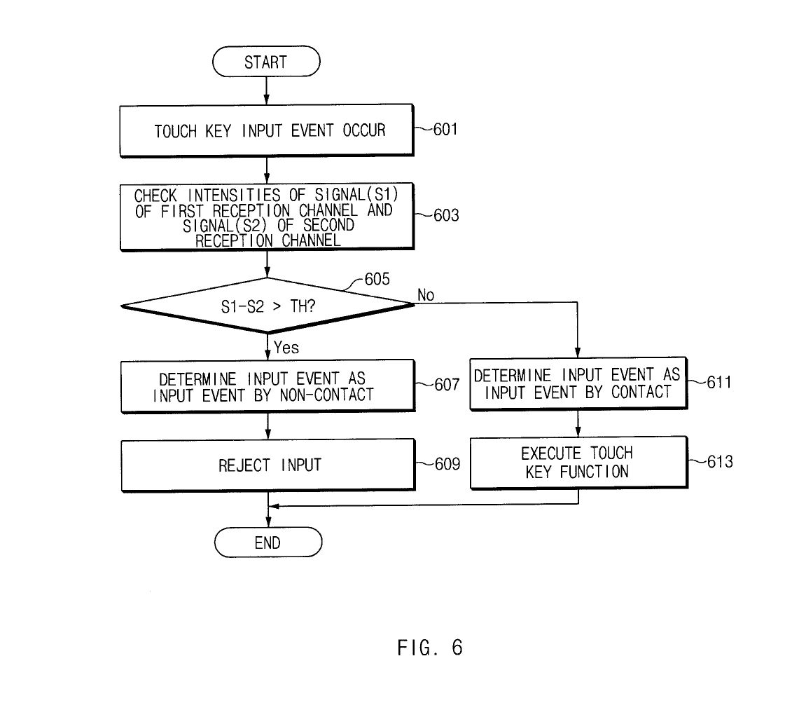

FIG. 6 is a flowchart illustrating a touch input recognition process of a touch key according to an embodiment of the present disclosure. In relation to FIG. 6, a description of features overlapping or corresponding to, or similar to, those of the above-discussed embodiments may be omitted. Additionally, FIG. 6 may be understood as a processing process in a situation in which a touch input by an electronic pen having a relatively thin pen tip (for example, less than 2 mm) occurs with respect to the touch key 190 for high-sensitive touch recognition.

Referring to FIG. 6, in operation 601, a touch key input event by an input means may occur. The input event may be recognized by the touch IC 180 by monitoring levels of signals in reception channels Rx1, Rx2, etc. In operation 603, the touch IC 180 may check a first signal S1 of a first reception channel (e.g. Rx1 or Rx3) and a second signal S2 of a second reception channel (e.g. Rx2 or Rx4) in the input event.

In operation 605, the touch IC 180 may determine whether a difference between the signal intensities (or reception sensitivities), of the first signal and the second signal exceeds a specified threshold value TH. This may be achieved by monitoring the first and second signal levels directly, or, monitoring and comparing signal to noise (SNR) ratios in each channel if the noise levels in each channel are about the same. According to another embodiment, the touch IC 180 may deliver the intensity levels of the first signal and the second signal to the processor 120 and the processor 120 may perform the determination. Hereinafter, the processor 120 is mainly described for convenience of description.

When it is determined at 605 that the difference between the signal intensities exceeds a threshold value, the processor 120 may determine the touch key input event as an input event by non-contact in operation 607. Here, an input event by non-contact may correspond to a touch input (that is, mutual hover) detected when an input means is spaced more than a predetermined distance away from the surface of the touch key 190 and does not contact it directly. In operation 609, when it is determined that the input event is the input event by non-contact, the processor 120 may reject the input event by the touch key.

In operation 605, when it is determined that the difference between the signal intensities is less than the threshold value, the processor 120 may determine the touch key input event as an input event by contact in operation 611. Here, the input event by contact may correspond to a touch input detected in a state that an input means directly contacts the surface of the touch key 190 or a state that an input means is close to the surface of the touch key 190 within a distance that satisfies a predetermined condition and is determined as contacting it substantially. In operation 613, when it is determined that the input event is determined as the input event by contact, the processor 120 may execute the input event by the touch key. For example, the processor 120 may execute a function mapped into a touch key.

According to an embodiment, when the touch input event occurs through physical contact by a first type input means (for example, a touch input by an electronic pen having a relatively small pen tip diameter, e.g. 1 mm), a reception intensity difference between the first signal and the second signal may be greater than the threshold value TH. In this case, the touch input event may be determined as an input event by non-contact. However, if the intensity of the second signal is less than a specified reference, the processor 120 may process the touch input event as a physical contact for a touch key in operation 613.

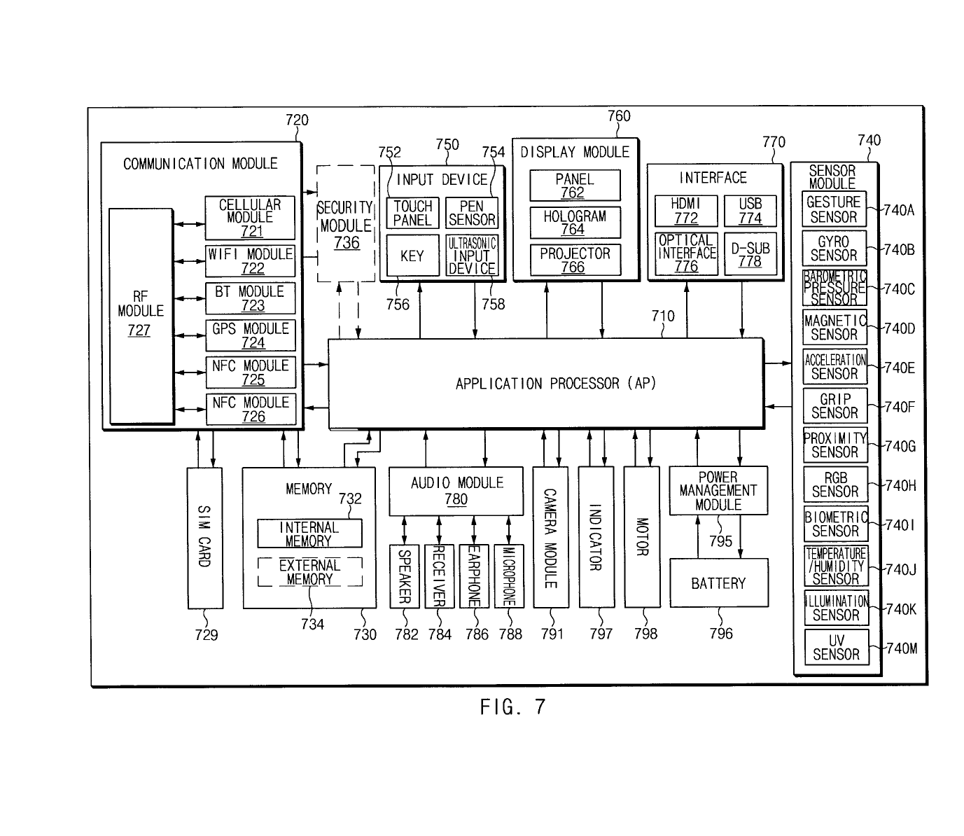

FIG. 7 is a block diagram of an electronic device, 700, according to an embodiment of the present disclosure. Electronic device 700, for example, may include all or part of the electronic device 100 shown in FIG. 1. The electronic device 700 may include at least one processor (for example, an application processor (AP)) 710, a communication module 720, a subscriber identification module (SIM) 729, a memory 730, a sensor module 740, an input device 750, a display 760, an interface 770, an audio module 780, a camera module 791, a power management module 795, a battery 796, an indicator 797, and a motor 798.

The processor 710 may control a plurality of hardware or software components connected thereto and also may perform various data processing and operations by executing an operating system or an application program. The processor 710 may be implemented with a system on chip (SoC), for example. According to an embodiment of the present disclosure, the processor 710 may further include a graphic processing unit (GPU) (not shown) and/or an image signal processor. The processor 710 may include at least part (for example, the cellular module 721) of components shown in FIG. 7. The processor 710 may load commands or data received from at least one of other components (for example, nonvolatile memory) and process them and may store various data in a nonvolatile memory.

The communication module 720 may have the same or similar configuration to the communication interface 170 of FIG. 1. The communication module 720 may include a cellular module 721, a WiFi module 722, a BT module 723, a GNSS module 724 (for example, a GPS module, a Glonass module, a Beidou module, or a Galileo module), a near field communication (NFC) module 725, a magnetic stripe transmission (MST) module 726, and a radio frequency (RF) module 727.

The cellular module 721, for example, may provide voice call, video call, text service, or internet service through communication network. According to an embodiment of the present disclosure, the cellular module 721 may perform a distinction and authentication operation on the electronic device 700 in a communication network by using a SIM (for example, a SIM card) 729. According to an embodiment of the present disclosure, the cellular module 721 may perform at least part of a function that the processor 710 provides. According to an embodiment of the present disclosure, the cellular module 721 may include a communication processor (CP).

Each of the WiFi module 722, the BT module 723, the GNSS module 724, the NFC module 725, and the MST module 726 may include a processor for processing data transmitted/received through a corresponding module. According to an embodiment of the present disclosure, at least part (for example, at least one) of the cellular module 721, the WiFi module 722, the BT module 723, the GNSS module 724, the NFC module 725, and the MST module 726 may be included in one integrated chip (IC) or IC package.

The RF module 727, for example, may transmit/receive communication signals (for example, RF signals). The RF module 727, for example, may include a transceiver, a power amp module (PAM), a frequency filter, a low noise amplifier (LNA), or an antenna. According to another embodiment of the present disclosure, at least one of the cellular module 721, the WiFi module 722, the BT module 723, the GNSS module 724, the NFC module 725, and the MST module 726 may transmit/receive RF signals through a separate RF module.

The SIM 729, for example, may include a card including a SIM and/or an embedded SIM and also may include unique identification information (for example, an integrated circuit card identifier (ICCID)) or subscriber information (for example, an international mobile subscriber identity (IMSI)).

The memory 730 (for example, the memory 130) may include an internal memory 732 or an external memory 734. The internal memory 732 may include at least one of a volatile memory (for example, dynamic RAM (DRAM), static RAM (SRAM), synchronous dynamic RAM (SDRAM)) and a non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash or NOR flash), hard drive, and solid state drive (SSD)).

The external memory 734 may further include flash drive, for example, compact flash (CF), secure digital (SD), micro Micro-SD, Mini-SD, extreme digital (xD), multi media card (MMC) or a memorystick. The external memory 734 may be functionally and/or physically connected to the electronic device 700 through various interfaces.

The security module 736, as a module having a relatively higher security level than the memory 730, may be a circuit for securing safe data storage and protected execution environment. The security module 736 may be implemented as a separate circuit and may include an additional processor. The security module 736, for example, may be in a detachable smart chip or a SD card or may include an embedded secure element (eSE) embedded in a fixed chip of the electronic device 700. Additionally, the security module 736 may run on a different OS from the electronic device 700. For example, it may run based on Java card open platform (JCOP) OS.

The sensor module 740 measures physical quantities or detects an operating state of the electronic device 700, thereby converting the measured or detected information into electrical signals. The sensor module 740 may include at least one of a gesture sensor 740A, a gyro sensor 740B, a barometric pressure sensor 740C, a magnetic sensor 740D, an acceleration sensor 740E, a grip sensor 740F, a proximity sensor 740G, a color sensor 740H (for example, a red, green, blue (RGB) sensor), a biometric sensor 7401, a temperature/humidity sensor 740J, an illumination sensor 740K, and an ultra violet (UV) sensor 740M. Additionally or alternatively, the sensor module 740 may include an E-nose sensor, an electromyography (EMG) sensor, an electroencephalogram (EEG) sensor, an electrocardiogram (ECG) sensor, an infra red (IR) sensor, an iris sensor, and/or a fingerprint sensor. The sensor module 740 may further include a control circuit for controlling at least one sensor therein. According to an embodiment of the present disclosure, the electronic device 700 may further include a processor configured to control the sensor module 740 as part of or separately from the processor 710 and thus may control the sensor module 740 while the processor 710 is in a sleep state.

The input device 750 may include a touch panel 752, a (digital) pen sensor 754, a key 756, or an ultrasonic input device 758. The touch panel 752 may use at least one of capacitive, resistive, infrared, or ultrasonic methods, for example. Additionally, the touch panel 752 may further include a control circuit. The touch panel 752 may further include a tactile layer to provide tactile response to a user.

The (digital) pen sensor 754, for example, may include a sheet for recognition as part of a touch panel or a separate sheet for recognition. The key 756 may include a physical button, an optical key, or a keypad, for example. The key 756, for example, may correspond to the above-mentioned touch key 190. Additionally, the input device 750 may provide a touch IC for processing a touch input through the key 756 or delivering it to the AP 710. According to an embodiment of the present disclosure, the touch IC may include a control circuit of the touch panel 752 or correspond to a control circuit. The ultrasonic input device 758 may detect ultrasonic waves generated from an input tool through a microphone (for example, the microphone 788) in order to check data corresponding to the detected ultrasonic waves.

The display 760 (for example, the display 160) may include a panel 762, a hologram device 764, or a proj ector 766. The panel 762 may have the same or similar configuration to the display 160 of FIG. 1. The panel 762 may be implemented to be flexible, transparent, or wearable, for example. The panel 762 and the touch panel 752 may be configured with one module. The hologram device 764 may show three-dimensional images in the air by using the interference of light. The projector 766 may display an image by projecting light on a screen. The screen, for example, may be placed inside or outside the electronic device 700. According to an embodiment of the present disclosure, the display 760 may further include a control circuit for controlling the panel 762, the hologram device 764, or the projector 766.

The interface 770 may include a high-definition multimedia interface (HDMI) 772, a universal serial bus (USB) 774, an optical interface 776, or a D-subminiature (sub) 778 for example. The interface 770, for example, may be included in the communication interface 170 shown in FIG. 1. Additionally or alternatively, the interface 770 may include a mobile high-definition link (MHL) interface, a secure Digital (SD) card/multi-media card (MMC) interface, or an infrared data association (IrDA) standard interface.

The audio module 780 may convert sound into electrical signals and convert electrical signals into sounds. At least some components of the audio module 780, for example, may be included in the input/output interface 150 shown in FIG. 1. The audio module 780 may process sound information inputted/outputted through a speaker 782, a receiver 784, an earphone 786, or a microphone 788.

The camera module 791, as a device for capturing a still image and a video, may include at least one image sensor (for example, a front sensor or a rear sensor), a lens, an image signal processor (ISP), or a flash (for example, an LED or a xenon lamp).

The power management module 795 may manage the power of the electronic device 700. According to an embodiment of the present disclosure, the power management module 795 may include a power management IC (PMIC), a charger IC, or a battery or fuel gauge, for example. The PMIC may have a wired and/or wireless charging method. As the wireless charging method, for example, there is a magnetic resonance method, a magnetic induction method, or an electromagnetic method. An additional circuit for wireless charging, for example, a circuit such as a coil loop, a resonant circuit, or a rectifier circuit, may be added. The battery gauge may measure the remaining amount of the battery 796, or a voltage, current, or temperature thereof during charging. The battery 796, for example, may include a rechargeable battery and/or a solar battery.

The indicator 797 may display a specific state of the electronic device 700 or part thereof (for example, the processor 710), for example, a booting state, a message state, or a charging state. The motor 798 may convert electrical signals into mechanical vibration and may generate vibration or haptic effect. Although not shown in the drawings, the electronic device 700 may include a processing device (for example, a GPU) for mobile TV support. A processing device for mobile TV support may process media data according to the standards such as digital multimedia broadcasting (DMB), digital video broadcasting (DVB), or mediaFLO™.

According to various embodiments of the present disclosure, components of the electronic device 700 may be included in a housing. The housing may cover at least part of the front surface or the rear surface of the electronic device 700. Additionally, the housing may cover a side surface of the electronic device 700 but according some embodiments of the present disclosure, at least one side surface of the electronic device 700 may be processed as the display 760. For example, a curved display may be prepared at a side surface of the electronic device 700.

A touch area may be disposed on at least a part of an arbitrary first surface (for example, the front surface) of the housing. For example, the display 760 may be disposed in a partial area of the front surface housing and a touch area for the key 756 may be prepared at a lower end part of the display 760. The electronic device 700 may include an integrated circuit (for example, the touch IC 180) for detecting an input through the touch area and the integrated circuit may be electrically connected to the AP 710.

Similar to that described with reference to FIG. 2, the electronic device 700 may include a first conductive line (for example, a driving line) for connecting between the integrated circuit and the touch area. Additionally, the electronic device 700 may include a second conductive line (e.g. a first reception channel line, which can also be referred to as a first detection line) that is electrically separated from the first conductive line and connects between the integrated circuit and the touch area and a third conductive line (e.g. a second reception channel line or detection line) that is electrically separated from the second conductive line and connects between the integrated circuit and the touch area. As described above in connection with FIGS. 2 and 3, the first reception channel line may output a first signal representing a first change in capacitance between conductive elements at a first location within the touch key conductive pattern. The second reception channel may provide a second signal representing a second change in capacitance between conductive elements at a second location within the touch key conductive pattern.

The touch area may include a first conductive pattern, a second conductive pattern, and a third conductive pattern. The first conductive pattern, the second conductive pattern, and the third conductive pattern may be electrically connected to the first conductive line, the second conductive line, and the third conductive line, respectively. According to an embodiment of the present disclosure, at least a part of the first conductive pattern may be disposed between at least a part of the second conductive pattern and at least a part of the third conductive pattern.

According to various embodiments of the present disclosure, the first conductive pattern may include a first comb structure and the second conductive pattern may include a second comb structure interlocked with the first comb structure. The touch area may achieve high sensitivity through the first conductive pattern and the second conductive pattern.

The third conductive pattern may be disposed to surround at least a part of the first comb structure and/or the second comb structure. The integrated circuit may transmit a first signal Tx through the first conductive line, and receive a second signal Rx1 through the second conductive line and a third conductive line Rx2 separated from the second conductive line. The integrated circuit may transmit the received second signal and third signal to the processor (for example, the AP 710) and the processor may determine a difference between the second signal and the third signal. The processor may start or change an operation of the electronic device in response to the difference.

According to various embodiments of the present disclosure, the display 760 may correspond to a touch screen display including the touch screen panel (for example, the touch panel 752). The touch screen display may be exposed to a first surface of the housing and may be connected to the integrated circuit. Additionally, the touch screen may include a plurality of first conductive lines (for example, a transmission channel) substantially extending parallel in a first direction (for example, a horizontal direction) and a plurality of second conductive lines (for example, a reception channel) substantially extending parallel in a second direction (for example, a vertical direction) vertical to the first direction and disposed to intersect the plurality of first conductive lines, and the plurality of first and second conductive lines may be electrically connected to the integrated circuit.

According to various embodiments of the present disclosure, when an input for a touch key is provided through different types of input means such as an electronic pen or a finger, it is possible to prevent malfunctions occurring due to an unintentional touch input by distinguishing an input recognized by directly contacting a touch key from an input recognized in a state of being spaced from a touch key and processing the touch input.

Besides the effects just mentioned, various other beneficial effects derived through the specification may be provided.

Each of the above-mentioned components of the electronic device according to various embodiments of the present disclosure may be configured with at least one component and the name of a corresponding component may vary according to the kind of an electronic device. According to various embodiments of the present disclosure, an electronic device according to various embodiments of the present disclosure may include at least one of the above-mentioned components, may not include some of the above-mentioned components, or may further include another component. Additionally, some of components in an electronic device according to various embodiments of the present disclosure are configured as one entity, so that functions of previous corresponding components are performed identically. The term “module” used in various embodiments of the present disclosure, for example, may mean a unit including a combination of at least one of hardware, software, and firmware. The term “module” and the term “unit”, “logic”, “logical block”, “component”, or “circuit” may be interchangeably used. A “module” may be a minimum unit or part of an integrally configured component. A “module” may be a minimum unit performing at least one function or part thereof. A “module” may be implemented mechanically or electronically. For example, “module” according to various embodiments of the present disclosure may include at least one of an application-specific integrated circuit (ASIC) chip performing certain operations, field-programmable gate arrays (FPGAs), or a programmable-logic device, all of which are known or to be developed in the future.

According to various embodiments of the present disclosure, at least part of a device (for example, modules or functions thereof) or a method (for example, operations) according to this disclosure, for example, as in a form of a programming module, may be implemented using an instruction stored in computer-readable storage media. When at least one processor (for example, the processor 120) executes an instruction, it may perform a function corresponding to the instruction. The non-transitory computer-readable storage media may include the memory 130, for example.

According to an embodiment of the present disclosure, a non-transitory computer readable recoding medium may store at least one instruction, and the at least one instruction, when executed by a processor of an electronic device, may be set to perform recognizing, by the electronic device, an input event including a first signal and a second signal detected from a touch key of the electronic device and processing the input event for the touch key based on a comparison result of the first signal and the second signal. Besides that, instructions for performing the above-mentioned various methods may be further stored in the storage medium.

The non-transitory computer-readable storage media may include hard disks, floppy disks, magnetic media (for example, magnetic tape), optical media (for example, CD-ROM, and DVD), magneto-optical media (for example, floptical disk), and hardware devices (for example, ROM, RAM, or flash memory). Additionally, a program instruction may include high-level language code executable by a computer using an interpreter in addition to machine code created by a complier. The hardware device may be configured to operate as at least one software module to perform an operation of various embodiments of the present disclosure and vice versa.

A module or a programming module according to various embodiments of the present disclosure may include at least one of the above-mentioned components, may not include some of the above-mentioned components, or may further include another component. Operations performed by a module, a programming module, or other components according to various embodiments of the present disclosure may be executed through a sequential, parallel, repetitive or heuristic method. Additionally, some operations may be executed in a different order or may be omitted. Or, other operations may be added.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. An electronic device comprising:
a housing including a first surface;
a touch key area disposed at a portion of the first surface;
an integrated circuit configured to detect an input through the touch key area;
a processor electrically connected to the integrated circuit; and
first, second and third conductive lines separated from one another and each connected between the touch key area and the integrated circuit,
wherein the first conductive line is a transmit channel line connected at a first point on the touch key area, the second conductive line is a first reception channel line providing a first signal indicative of a first change in capacitance, due to at least one external object, between conductive elements at a first location within the touch key area, and the third conductive line is a second reception channel line providing a second signal indicative of a second change in capacitance, due to the at least one external object, between conductive elements at a second location within the touch key area.

2. The electronic device of claim 1, wherein the touch key area comprises:
a first conductive pattern electrically connected to the first conductive line;
a second conductive pattern electrically connected to the second conductive line; and
a third conductive pattern electrically connected to the second conductive line.

3. The electronic device of claim 2, wherein at least a portion of the first conductive pattern is disposed between at least a portion of the second conductive pattern and at least a portion of the third conductive pattern.

4. The electronic device of claim 2, wherein the first conductive pattern comprises a first comb structure and the second conductive pattern comprises a second comb structure interlocked with the first comb structure.

5. The electronic device of claim 4, wherein the third conductive pattern surrounds at least a part of the first comb structure and/or the second comb structure.

6. The electronic device of claim 1, wherein the integrated circuit receives the first and second signals and transmits the received first and second signals to the processor.

7. The electronic device of claim 6, wherein the processor determines a difference between the first signal and the second signal.

8. The electronic device of claim 7, wherein the processor starts or changes an operation of the electronic device in response to the difference.

9. The electronic device of claim 8, wherein when a difference between the first signal and the second signal is less than a threshold value, the processor starts or changes an operation of the electronic device.

10. The electronic device of claim 8, wherein when a difference between the first signal and the second signal is greater than a threshold value, the processor rejects the input through the touch key area.

11. The electronic device of claim 8, wherein when a difference between the first signal and the second signal is greater than a threshold value and an intensity of the second signal is less than a specified reference, the processor starts or changes an operation of the electronic device.

12. The electronic device of claim 1, further comprising a touch screen display exposed on the first surface, wherein the touch screen display is electrically connected to the integrated circuit.

13. The electronic device of claim 1, wherein:
the touch key area is a first touch key area associated with a first function, and the electronic device further comprising a second touch key area associated with a second function;
the first conductive line provides a transmit signal to conductive circuit patterns in each of the first and second touch key areas; and
further comprising fourth and fifth conductive lines connected to respective points of the second touch key area, the fourth and fifth conductive lines being respective third and fourth reception channel lines providing signals indicative of respective changes in capacitance within the second touch key area.

14. An electronic device comprising:
a housing including a first surface;
a touch key area disposed at a portion of the first surface;
an integrated circuit configured to detect an input through the touch key area; and
first, second and third conductive lines separated from one another and each connected between the touch key area and the integrated circuit.

15. The electronic device of claim 14, wherein the first conductive line is a transmit channel line connected at a first point on the touch key area, the second conductive line is a first reception channel line providing a first signal indicative of a first change in capacitance, due to at least one external object, between conductive elements at a first location within the touch key area, and the third conductive line is a second reception channel line providing a second signal indicative of a second change in capacitance, due to the at least one external object, between conductive elements at a second location within the touch key area.

16. The electronic device of claim 15, wherein when a difference between the first signal and the second signal is less than a threshold value, the integrated circuit starts or changes an operation of the electronic device.

17. The electronic device of claim 16, wherein when a difference between the first signal and the second signal is greater than the threshold value, the integrated circuit rejects the input through the touch key area.

18. The electronic device of claim 15, wherein when a difference between the first signal and the second signal is greater than a threshold value and an intensity of the second signal is less than a specified reference, the integrated circuit starts or changes an operation of the electronic device.

19. A touch input processing method of an electronic device including a touch key area, the method comprising:
recognizing a first signal and a second signal detected by an input on the touch key area; and
processing the input on the touch key area based on at least a comparison result of the first signal and the second signal.

20. The method of claim 19, wherein the processing of the input comprises, when a difference between the first signal and the second signal is less than a threshold value, performing a function corresponding to the touch key area.
